(19) United States
(12) Patent Application Publication
(10) Pub. No.: US 2025/0313380 A1
(43) Pub. Date: Oct. 9, 2025

(54) PRODUCT CONTAINERS AND CONTAINER ASSEMBLIES

(71) Applicant: Kenzinc LLC, Oxford, CT (US)

(72) Inventor: Drew Pickering, Oxford, CT (US)

(21) Appl. No.: 19/016,390

(22) Filed: Jan. 10, 2025

Related U.S. Application Data
(60) Provisional application No. 63/573,839, filed on Apr. 3, 2024.

(51) Int. Cl. B65D 25/10; B65D 43/02; G01F 19/00

(52) U.S. Cl. CPC B65D 25/102; B65D 43/0202; G01F 19/002; B65D 2543/00092

(57) ABSTRACT

The present disclosure provides containers and container assemblies for storing and dispensing products, such as infant formula, nutritional and fitness supplements, coffee, sugar, flour, dissolvable cannabinoid, edible cannabis, gummies, flowers, buds, candy, chocolates, baked goods and the like. The containers have a measuring and dispensing device, such as a utensil, removably secured to an internal wall of the container to prevent the utensil from becoming buried within the product. The container may be formed from first and second portions that are molded separately from each other and then joined together, allowing it to be manufactured quickly, easily, and inexpensively.

### CROSS-REFERENCE TO RELATED APPLICATIONS

This application claims the benefit of U.S. Provisional Application Ser. No. 63/573,839, filed Apr. 3, 2024, the complete disclosure of which is incorporated herein by reference in its entirety for all purposes.

### TECHNICAL FIELD

This description generally relates to containers for storing and dispensing products, and to container assemblies having a measuring and/or dispensing device, such as a scoop, tweezer, spoon, or other utensil, removably secured within the container.

### BACKGROUND

Products in granular or powdered form, such as infant formula, nutritional and fitness supplements, coffee, sugar, flour, dissolvable cannabinoid and the like, are often packaged in containers. Utensils, such as scoops, spoons, ladles and like, are typically provided within the container for measured dispensing of the granular or powder contents. Products in other forms, such as edible cannabis, gummies, flowers, buds, candy, chocolates, baked goods and the like, are also often packaged in containers. Utensils, such as tweezers, spoons, picks, forks and the like, may be provided within the container for distributing or dispensing these products.

Users of such containers have found that the current packaging of these containers is difficult to handle because the utensil becomes buried in the products or the powdered or granular material. When a user wishes to withdraw a portion of the product from the container, he or she must first dig around in the interior of the container to find the utensil. This process contaminates the contents and soils the hands of the user. In some cases, it can lead to undesirable spillage as the user's product-coated fingers and hands are removed from the interior of the container. Once the utensil is located and withdrawn from the container, it may also be covered with the powder, which leads to further waste and/or spillage of the product.

Attempts to solve these problems have involved attaching a scoop to an interior or exterior wall of the container or the container lid with a mechanical fastener or adhesive. This generally prevents the scoop from becoming buried within powder material. The scoop in these containers, however, can be difficult to grasp because it is too tightly fastened to the container. In addition, these mechanical fasteners do not adequately seal the lid to the container, which can lead to degradation of the granulated or powdered material. Moreover, they create challenges and additional costs for the manufacturing process of the containers. Most, if not all, containers attempt to solve this problem by adding extra material to be used with specific manufactured scoops.

It would therefore be desirable to provide improved dispenser containers that solves some of the challenges of existing products. It would also be desirable to provide such a container that is relatively easy and inexpensive to manufacture without requiring multiple components and/or using secondary features or products that further contribute to plastic material waste.

### SUMMARY

Containers are provided for storing and dispensing products, such as infant formula, nutritional and fitness supplements, coffee, sugar, flour, dissolvable cannabinoid, edible cannabis, gummies, flowers, buds, candy, chocolates, baked goods and the like. Container assemblies are also provided that may include a measuring and dispensing device, such as a utensil, removably secured to the interior of the container to prevent the utensil from becoming buried within the product.

In one aspect, a container for use with a utensil or dispensing device comprises a closed lower end, an upper end with an opening and a peripheral wall between the upper and lower ends defining an interior of the container. The container further comprises a projection extending from the peripheral wall into an interior of the container and configured to removably retain the utensil within the interior of the container.

The container is designed to removably retain a dispensing device, such as a scoop, ladle, cup, dipper, tweezer, spoon, fork, pincer or the like, within the interior of the container. The projection forms an internal holder that allows the user to remove the dispensing device easily and quickly from the container without having to dig through the product (which may include particles, such as gummies, flowers or buds, and/or granulated, ground, or powdered material) to find the dispensing device. The projection or projections may be located on any portion of the peripheral wall of the container to satisfy the needs of the user.

In embodiments, the container includes a mating feature for cooperating with a lid, which for example may include a sealable lid, to preserve the product housed within container. The lid may be coupled to the container with any suitable component, such as threaded connection, a hinged connection, or one or more mating features that cooperate with mating features on the upper end of container, such as snap-lock, snap fit or the like. The projection is disposed between the mating feature and the closed lower end of the container to ensure that the projection does not interfere with the sealed connection between the lid and the container.

In embodiments, the projection comprises an elongate body that forms a space or gap between the projection and the inner surface of the peripheral wall. The space or gap is sized to receive a portion of the dispensing device, such that this portion of the dispensing device extends through the space to retain the utensil below the upper end of the container. This space between the projection and the peripheral wall is sized to prevent the dispensing device from becoming loose and falling into the media.

In embodiments, the projection is sized and positioned such that the utensil extends through the space or gap in a direction having an angle of about 45 degrees to about 90 degrees, or about 60 degrees to about 90 degrees, or about 75 degrees to about 90 degrees relative to the closed lower end. In an exemplary embodiment, the utensil generally extends in a substantially vertical direction, or a direction that is substantially perpendicular to the plane formed by bottom end of container. This ensures that the utensil may be easily grasped by the user when the lid is opened and the user desires to use the utensil to retrieve product from the container.

In embodiments, the container comprises first and second projections each having a first end coupled to, or integral with, the inner surface of the peripheral wall of the container, and a second end extending into the interior of the container. The first and second projections cooperate with each other to retain the utensil to the inside surface of the container.

In embodiments, each projection has an elongate body with a first end in contact with the interior surface of the container and a second end extending into the interior of the container. In some embodiments, the first ends extend from the interior surface of the container. In other embodiments, the first ends are formed outside of the container and extend through the interior surface of the container. The projections form a space between the projections and the interior surface sized to receive the handle of the dispensing device, which may, for example, comprise a scoop, cup, dipper, ladle, tweezer, pincer, spoon or the like.

In embodiments, the projections extend in a transverse direction relative to the peripheral wall of the container. In an exemplary embodiment, the projections are substantially perpendicular to the peripheral wall (i.e., horizontal when the container rests on a surface right side up).

In embodiments, the seconds ends of the projections come together such that they are adjacent to, or near, each other. In other embodiments, the projections contact each other, or overlap with each other to enclose the space between the projections and the interior surface of the container. In some embodiments, a thermal bond is created between the second ends of the projections. The first and second projections may be non-congruent. The first and second projections may be substantially aligned with each other. Alternatively, the first and second projections may be misaligned with each other. In these embodiments, the offset or misaligned projections may be positioned to influence the utensil into a directed position that secures the utensil within the container.

In embodiments, the peripheral wall has an outer surface and the first and second projections each comprise an internal channel. The internal channel of each of the first and second projections extends from the outer surface of the peripheral wall to the second end of the projections. The internal channel of the first projection may communicate with the internal channel of the second projection to form a passage from the outer surface of a first side of the peripheral wall to the outer surface of a second side of the peripheral wall.

In various embodiments, the projection and the container are molded together from a single mold. In other embodiments, the container comprises a first portion and a second portion that are molded as separately from each other and then joined together. In one such embodiment, the first and second portions each comprise one of the projections. This allows the container to be manufactured quickly, easily, and inexpensively. For example, the projections may be formed via molding techniques by pressing, deforming or pushing material from the peripheral wall inwardly towards the interior of container. This allows for shrink packaging to form inward, which creates a stronger slip resistance that often occurs with shrink sleeve labeling of containers.

The container may comprise any suitable shape, such as cylindrical, rectangular, square, triangular, cuboid, obloid, pentagonal, hexagonal, or the like. In an exemplary embodiment, the container comprises a substantially cylindrical shape and the first and second portions each comprise a semi-cylindrical shape. The first and second portions may be substantially congruent with each other, which facilitates the manufacturing process.

In embodiments, the dispensing device comprises a scoop having a handle and a bowl. The handle extends through the space between the peripheral wall of the container and the projection(s) and the bowl of the dispensing device rests on the projection below the upper end of the container. Thus, the bowl may be easily grasped by the user to remove the scoop from the container.

In various embodiments, the space between the projection and the interior wall of the container is smaller than at least one dimension of the bowl, such as the height or depth of the bowl. This allows one portion of the dispensing device to be inserted through this space such that another portion of the dispending device rests on the projection below the upper end of the container. In some embodiments, the handle of the dispensing device may have an interference fit with internal structures (e.g., projections and peripheral wall) of the container.

In embodiments, the dispensing device comprises a utensil, such as a tweezer, having first and second legs pivotally coupled together at a hinge. The hinge may be placed on the projection(s) such that the first and second legs extend downwardly on either side of the projections(s). Thus, the hinge may be easily grasped by the user to remove the tweezer from the container.

One of the benefits of the containers described herein is that the bowl of the scoop (or the hinge of the utensil) may face in any direction within the container (e.g., the bowl or hinge may be rotated 360 degrees) and still remain retained by the projections within the interior of the container. In certain embodiments, the projections may include one or more features (or the projections may be located at a specific position within the container) to position the bowl of the scoop or the hinge of the utensil in any direction (or a specific direction) as it rests upon the projections.

In another aspect, an infant formula product is provided that comprises the container and scoop described above. The infant formula product further comprises a granulated, powdered or ground infant formula.

In another aspect, a nutritional supplement product is provided that comprises the container and scoop described above. The nutritional supplement product further comprises a powdered, granulated or ground nutritional supplement composition.

In another aspect, a cannabis product is provided that comprises the container and the tweezer described above. The cannabis product may further comprise dissolvable cannabinoid, edible cannabis, gummies, flowers, buds, candy, chocolates, baked goods and the like.

In another aspect, a container assembly comprises a container having a closed lower end, an upper end with an opening and a peripheral wall between the upper and lower ends defining an interior of the container. The assembly further comprises a dispensing device, such as a utensil, and a projection or tab extending from the peripheral wall into an interior of the container. The projection is configured to removably retain the dispensing device within the interior of the container.

In another aspect, a method for manufacturing a container comprises molding first and second portions of the container. The first and second portions each comprise a lower end with a bottom wall, an open upper end, and a peripheral wall between the upper and lower ends, at least one of the first and second portions comprises a projection extending from an inner surface of the peripheral wall. The method further comprises joining the first portion with the second portion.

In various embodiments, the first and second portions each comprise one of the projections and the projections are bonded to each other. In an exemplary embodiment, the inner ends of the projections are thermally bonded or fused together. Thermally bonding the projections to each other prevents media from becoming trapped between the projections. This allows the container to be manufactured quickly, easily, and inexpensively. For example, the projections may be formed via molding techniques by pressing, deforming or pushing material from the peripheral wall inwardly towards the interior of container.

In embodiments, the seconds ends of the projections come together such that they are adjacent to, or near, each other. In other embodiments, the projections contact each other, or overlap with each other to enclose the space between the projections and the interior surface of the container. In some embodiments, a thermal bond is created between the second ends of the projections. The first and second projections may be non-congruent. The first and second projections may be substantially aligned with each other. Alternatively, the first and second projections may be misaligned with each other.

In embodiments, the peripheral wall has an outer surface and the first and second projections each comprise an internal channel. The internal channel of each of the first and second projections extends from the outer surface of the peripheral wall to the second end of the projections. The internal channel of the first projection may communicate with the internal channel of the second projection to form a passage from the outer surface of a first side of the peripheral wall to the outer surface of a second side of the peripheral wall.

In another aspect, a method for manufacturing a container comprises molding the container to form a lower end with a bottom wall, an open upper end, and a peripheral wall between the upper and lower ends and pressing, deforming or pushing a portion of the outer surface of the peripheral wall inwardly to form a projection within the interior of the container.

In embodiments, the method comprises pressing a second portion of the outer surface of the peripheral wall inwardly to form a second projection within the interior of the container. The first and second projections may be pressed towards each other. The first and second projections may be pressed inwardly into the container such that a first internal end of the first projection is adjacent to a second internal end of the second projection.

In embodiments, the first internal end contacts the second internal end. In an exemplary embodiment, the method comprises thermally fusing the first internal end to the second internal end.

In embodiments, the first and second projections are pressed inwardly in a direction transverse to, or substantially perpendicular to, the peripheral wall. The projections may be pressed inwardly to form a space between the projections and the peripheral wall. The space is sized to receive a portion of a dispensing device.

### BRIEF DESCRIPTION OF THE DRAWINGS

The accompanying drawings, which are incorporated in and constitute a part of this specification illustrate several embodiments of the disclosure and together with the description, explain the principles of the disclosure.

FIG. 1 is a perspective view of a representative measuring and dispensing device;

FIG. 2 is a side sectional view of a container and the device of FIG. 1;

FIG. 3 is a side sectional view of the container and the device taken along a plane perpendicular to FIG. 2;

FIG. 4 is a top view of the container;

FIG. 5 is a side sectional view of another embodiment of a container for a measuring and dispensing device;

FIG. 6 is a top view of another embodiment of a container for a measuring and dispensing device;

FIG. 7 is a side sectional view of another embodiment of a container for a measuring and dispensing device;

FIG. 8 is a side sectional view of the container of FIG. 7 taken along a plane perpendicular to FIG. 7;

FIG. 9 is a top view of the container of FIG. 7;

FIG. 10A is a perspective view of a measuring and dispensing device;

FIG. 10B is a side view of the device of FIG. 10A;

FIG. 10C is a bottom view of the device of FIG. 10A;

FIG. 11A is a perspective view of another embodiment of a container for a dispensing device;

FIG. 11B is a cross-sectional view of the container of FIG. 11A and a measuring and dispensing device for use with the container;

FIG. 11C illustrates the measuring and dispensing device disposed within the container;

FIG. 11D is a partial isometric view of one portion of the container of FIG. 11A;

FIG. 11E includes the measuring and dispensing device within the container;

FIG. 11F is a side split view of the container of FIG. 11A;

FIG. 12A is a top sectional view of a container for a dispensing device;

FIG. 12B is a top sectional view of another container for a dispensing device;

FIG. 12C is a top view of the container of FIG. 12B;

FIG. 12D is a top view of the container of FIG. 12A;

FIG. 13 is a partially schematic view of another container for a dispensing device;

FIG. 14 is a partially schematic view of another container for a dispensing device;

FIG. 15A illustrates a container assembly including a tweezer; and

FIG. 15B illustrates the container assembly of FIG. 15A with the tweezer retained within the interior of the container.

### DESCRIPTION OF THE EMBODIMENTS

This description and the accompanying drawings illustrate exemplary embodiments and should not be taken as limiting, with the claims defining the scope of the present disclosure, including equivalents. Various mechanical, compositional, structural, and operational changes may be made without departing from the scope of this description and the claims, including equivalents. In some instances, well-known structures and techniques have not been shown or described in detail so as not to obscure the disclosure. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Containers are provided for storing and dispensing products, such as infant formula, nutritional and fitness supplements, coffee, sugar, flour, dissolvable cannabinoid, edible cannabis, gummies, flowers, buds, candy, chocolates, baked goods and the like. Container assemblies are also provided that may include a measuring and dispensing device, such as a utensil. The containers comprise an internal securing feature for removably securing the utensil to the interior of the container to prevent the utensil from becoming buried within the product.

In certain embodiments, the container assemblies include a measuring and dispensing device for powered or granulated material, such as infant formula, nutritional and fitness supplements, coffee, sugar, flour and the like. In other embodiments, the container assemblies may include a utensil, such as a tweezer, spoon, fork, pick or the like, for retrieving product from the container, such as dissolvable cannabinoid, edible cannabis, gummies, flowers, buds, candy, chocolates, baked goods and the like.

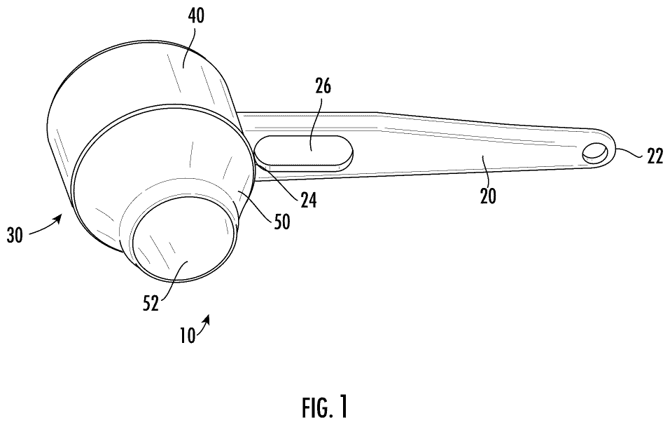

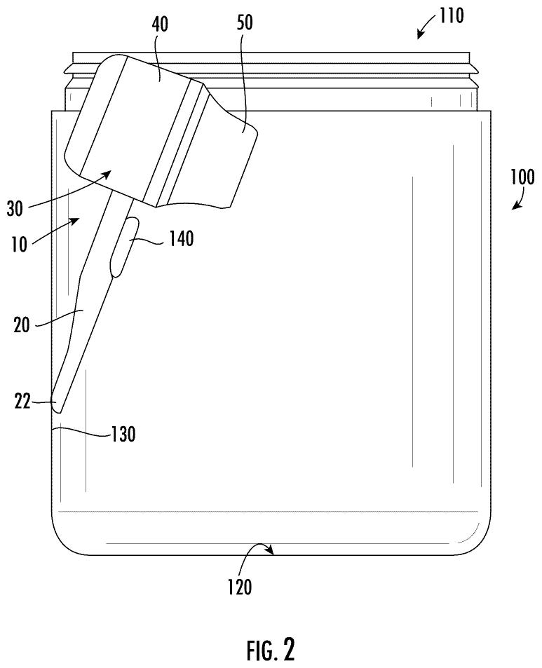

FIG. 1 illustrates a representative measuring and dispensing device 10, such as a scoop, cup, dipper, ladle, spoon or the like, for use in scooping media from a container 100 (see FIG. 2) and transferring that substance to another receptacle, such as a water bottle, baby bottle, coffee pot or the like. The media is, for example, any powdered, granulated, ground or other formed substance such as a powder milk product used to feed an infant, or a nutritional substance used by an athlete, coffee, tea, or any other media that may be easily scooped by the presently described dispensing device. The substance need not be a fine powder, but may be, for example, a granular or ground particulate or liquid.

Scoop 10 generally comprises an elongated handle 20 formed on, or coupled to, a bowl 30. Bowl 30 comprises a substantially cylindrical container 40 and a substantially conical dispensing element 50 with an opening 52 for receiving and dispensing particles, such as powder or other granulated or ground particles. Handle 20 comprises a first end 24 coupled to, or integral with, bowl 30 and a second end 22 that may be grasped by a user. Handle may include one or more window(s) 26 for allowing excess unwanted media to pass through during scooping. Handle 20 may be curved or contoured to prevent accumulation of unwanted media on any surface of handle 20. In certain embodiments, the handle may be straight and/or it may contain strengthening structures. In certain embodiments, handle 20 may not include windows 26.

In certain embodiments, handle 20 and bowl 30 may be formed from a single piece molded construction. The scoop 10 may be molded from a suitable plastic material, which may be molded by blow molding, extrusion, injection, or other manufacturing disciplines. Suitable plastics for forming the scoop include, may include but are not limited to, various polymers, such as nylon (polyamide), acrylic, polyoxymethylene (POM), polystyrene (PS), acrylonitrile butadiene styrene (ABS), polypropylene (PP), polyethylene, thermoplastic polyurethane (TPU), thermoplastic rubber (TPR), high density polyethylene (HDPE), low density polyethylene (LDPE), polyvinyl chloride (PVC), polyethylene terephthalate (PET), and thermoplastic elastomers (TPE) and combinations thereof.

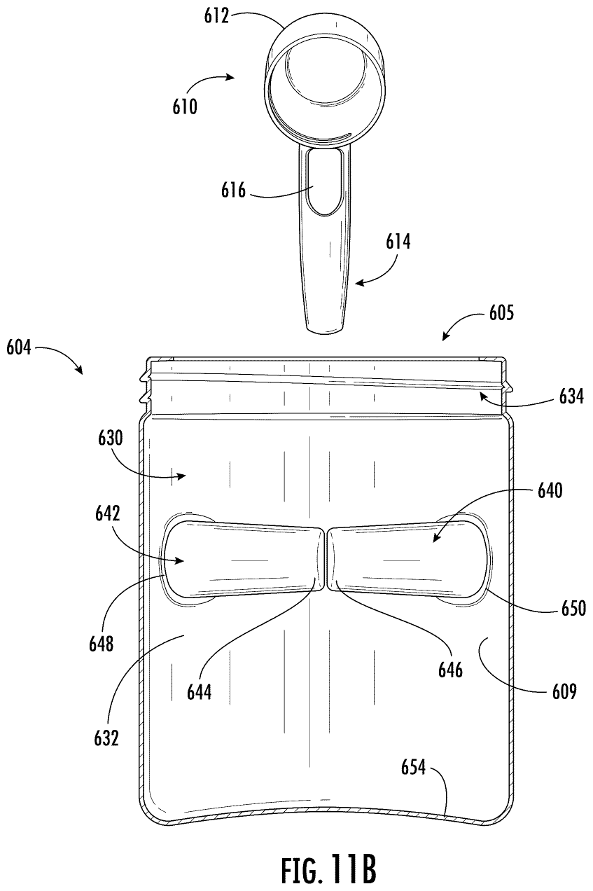

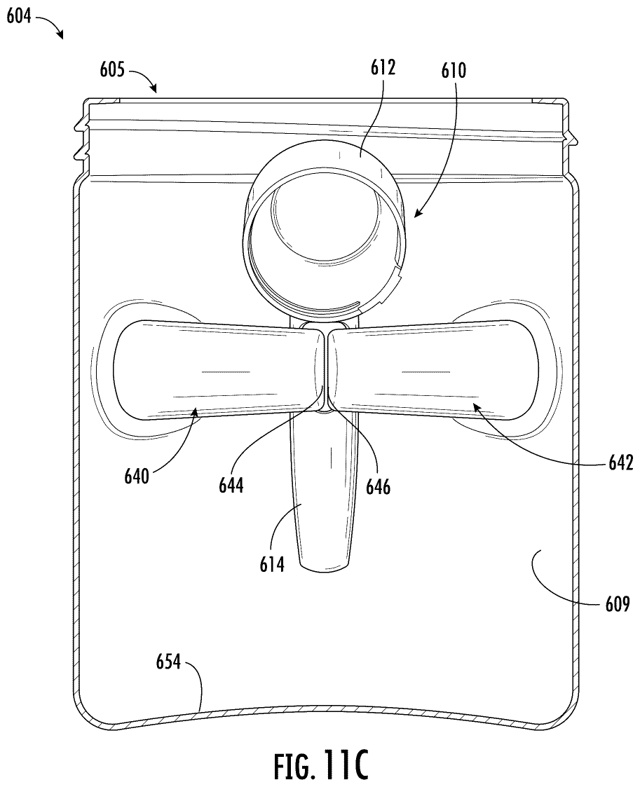

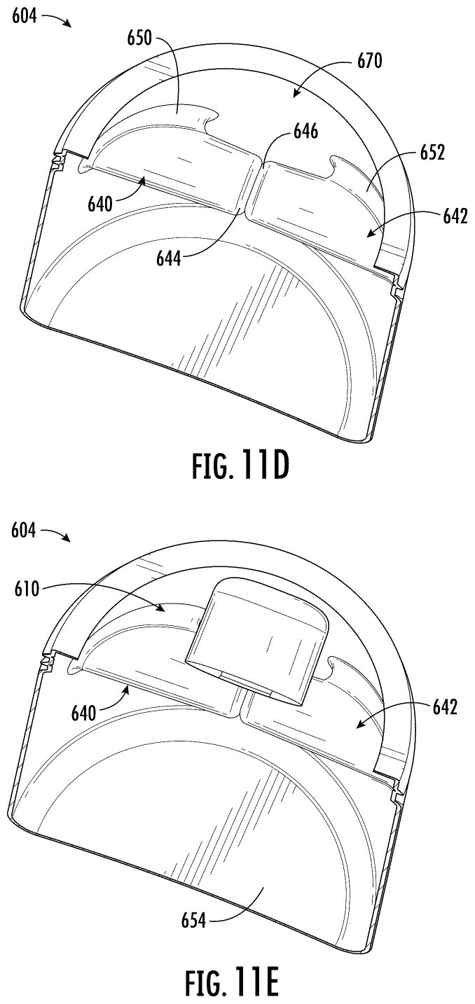

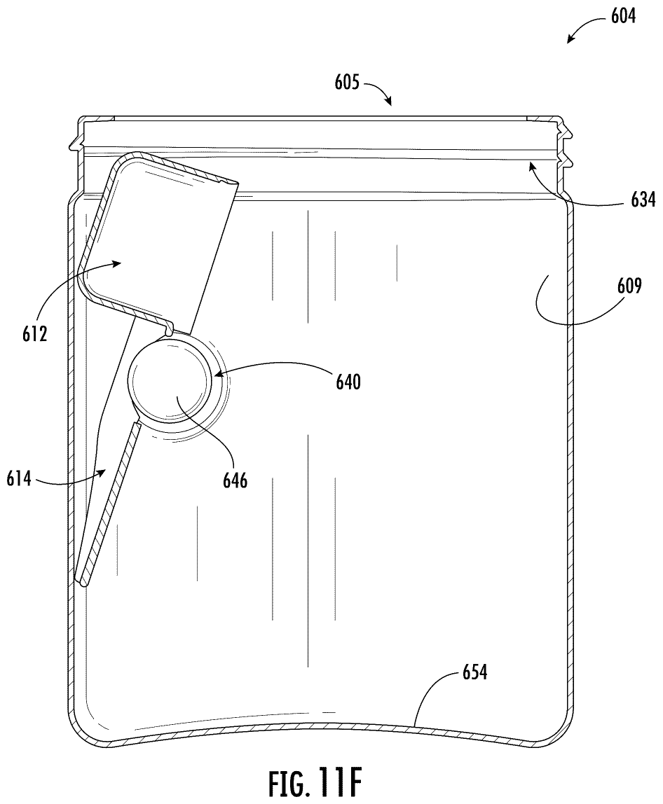

Of course, other configurations for scoop 10 are contemplated. Containers 100, 200, 300, 400 and 604 may be used with any commercially available scoop, and/or the scoops described in U.S. Pat. Nos. 7,441,676, 10,029,821 and 9,542,441 the complete disclosures of which are incorporated herein by reference for all purposes. For example, scoop 10 may have a substantially cylindrical bowl (i.e., without the conical dispensing element). Scoop 10 may have the configuration described below and illustrated in FIGS. 11A-11C. Alternatively, scoop 10 may have a substantially conical shape (i.e., without the cylindrical component). In other embodiments, scoop 10 may comprise any suitable shape, such as rectangular, square, triangular, cuboid, obloid, pentagonal, hexagonal, or the like. In certain embodiments, scoop 10 may include deformable or pinchable surfaces or handle members designed to flex inwardly to form a spout. Such a configuration is described in commonly assigned co-pending U.S. application Ser. No. 17/900,816, filed Aug. 31, 2022, the complete disclosure of which is incorporated herein by reference for all purposes.

Referring now to FIGS. 2-4, scoop 10 may be used in conjunction with a container 100 to form a container assembly. As shown, container 100 generally comprises a closed lower end 120, an open upper end 110 and an internal surface 130 extending between upper and lower ends 110, 120. Container 110 may be composed of various materials suitable to hold a granulated flowable material. Various examples include, but are not limited to, being constructed of a metal material, tin, metal plated tin, aluminum or other metal or alloy. Alternatively, the container 100 may be constructed of a suitable plastic material that is recyclable or non-recyclable, such as for example, but not limited to, polystyrene, polystyrene-acrylonitile, acrylonitile-butadiene-styrene, styrene-maleic anhydride, polycarbonate, high density polyethylene, polyethylene copolymers, polypropylene, polypropylene copolymers, polyethylene terephthalate, polyvinylcyclohexane, and the like

Container 100 further comprises a lid (not shown) that seals open upper end 110 to preserve the granulated material housed within container 110. In certain embodiments, the lid may comprise a threaded connection with container 100 to seal container. In other embodiments, various types of tight interference type sealing connections may be provided between the lid and upper end 110 of container 100. For example, the connection may be a hinged connection, such as a mechanical hinge, a living hinge or the like, that allows the lid to be opened and closed. Alternatively, the lid may comprise one or more mating features that cooperate with mating features on the upper end of container, such as snap-lock, snap fit or the like. The lid may include one or more components, such as a sheet, film or the like, that are formed from a material substantially impervious to oxygen, moisture and/or light, such as aluminum foil, or a metallic, polymeric, or other type of foil.

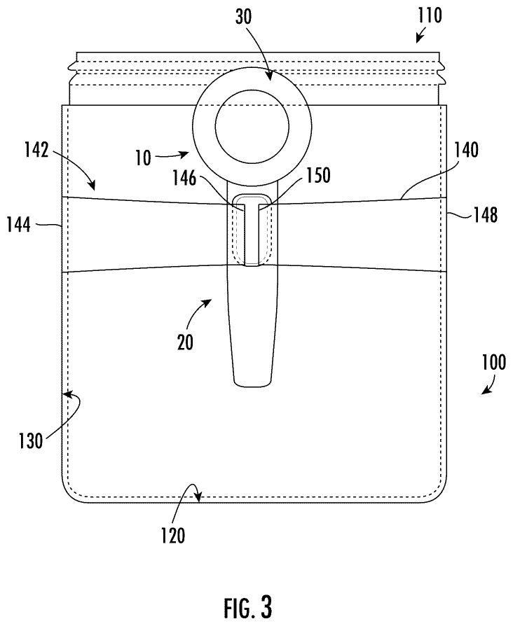

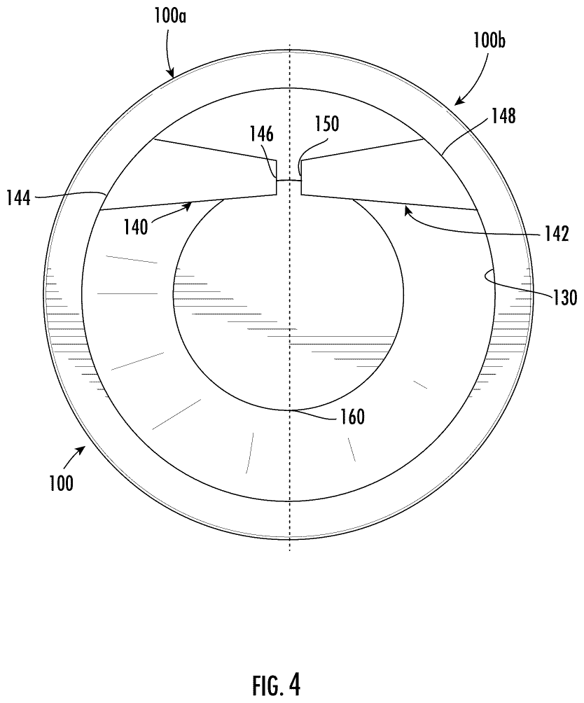

As shown in FIGS. 3 and 4, container 100 further comprises first and second projections or tabs 140, 142 extending either from internal surface 130, or from the outer surface of container 100 (i.e., through the container wall). Tabs 140, 142 each have a first end 144, 148 coupled to, or integral with, internal surface 130 and a second open end 146, 150 facing each other within the interior of container 100. Second ends 146, 150 are preferably adjacent to, or near, each other within container 100. In certain embodiments, ends 146, 150 are spaced from each other. In other embodiments, ends 146, 150 contact each other. Tabs 140, 142 may taper from first ends 144, 148 to second ends 146, 150. Alternatively, they may taper in the opposite direction, or they may have parallel sides (i.e., rectangular in shape). Tabs 140, 142 may be substantially straight, or they may have an arcuate shape bending inwards or outwards within container 100.

Tabs 140, 142 form a scoop holder within container 100. Thus, tabs 140, 142 are preferably spaced away from interior surface 130 by a distance suitable to allow handle 20 of scoop 10 to pass between tabs 140, 142 and interior surface. Tabs 140, 142 are close enough to interior surface 130 to prevent bowl 30 of scoop 10 from passing downward through this space. Thus, bowl 30 rests upon tabs 140, 142 within container 100 and does not get buried within the granulated media housed in container 100. In addition, tabs 140, 142 are preferably positioned such that the entire bowl 30 is disposed below the upper surface 112 of upper end 110 of container 100 to allow the lid to close container 100 with scoop 10 inside.

Container 100 may be manufactured in any suitable manner known by those of skill in the art. In one embodiment, container 100 is manufactured by molding first and second portions 100a, 100b of container 100 separately and then joining the portions together. Each portion 100a, 100b preferably comprises one of the tabs 140, 142. Container 100 may comprise any suitable shape depending on the application, such as cylindrical, conical, rectangular prism, cubical, pyramidal, spherical and the like. The walls of container between lower end 120 and upper end may be substantially straight, arcuate, or any other suitable shape. In an exemplary embodiment, (shown in FIG. 4), container 100 comprises a substantially cylindrical shape. Thus, first and second portions 100a, 100b are preferably congruent with each other, each forming a suitable shape, such as semi-cylindrical, tapered or the like. Each of first and second portions 100a, 100b comprise one of the tabs 140, 142. Portions 100a, 100b are then joined together along the dotted line 160 shown in FIG. 4. This allows container 100 to be manufactured quickly, easily, and inexpensively.

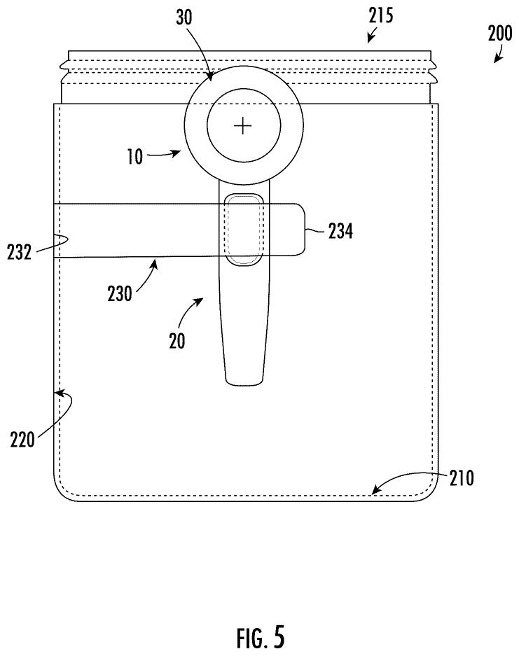

Referring now to FIG. 5, an alternative embodiment of a container 200 will now be described. As shown, container 200 includes a closed distal end 210, an open upper end 215 and an internal surface 220 therebetween. In this embodiment, container 200 comprises a single tab 230 having a first end 232 coupled to, or integral with, internal surface 200 and a second open end 234. Second end 234 of tab 230 extends across at least the center line of the interior of container 200 such that tab 230 suitably holds scoop 10 to the interior surface of the container. In other embodiments, second open end 234 may be adjacent to, or near, the other side of internal surface 200. This configuration provides a space between tab 230 and internal surface 220 that forms the scoop holder. Tab 230 may be substantially straight with parallel sides, or it may taper from first end 232 to second end 234. Alternatively, it may taper in the opposite direction.

Container 200 may be manufactured in any suitable manner known by those of skill in the art. In one embodiment, for example, the entire container 200 and tab 230 are molded in a single piece. In another embodiment, container 200 may contain first and second portions, such as the first and second portions 100a, 100b shown in FIG. 4. In this embodiment, tab 230 is molded as a single piece with one of the portions.

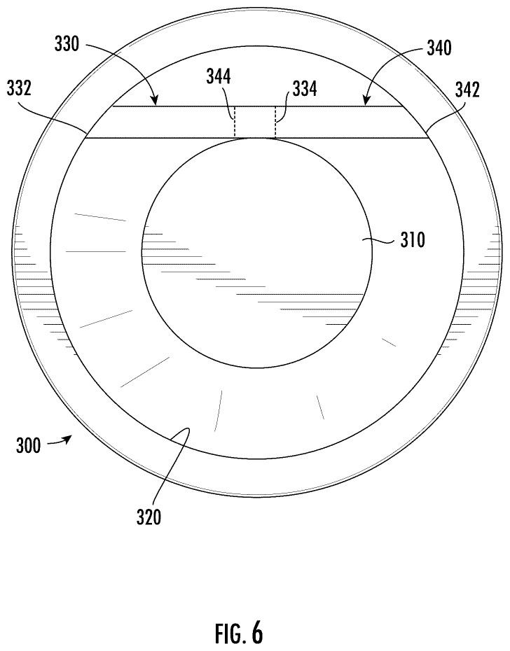

Referring now to FIG. 6, another embodiment of a container 300 comprises a closed distal end 310, an open upper end (not shown) and an internal surface 320 therebetween. In this embodiment, container 300 comprises first and second projections or tabs 330, 340 extending from, or through, internal surface 320. Tabs 330, 340 each have a first end 332, 342 coupled to, or integral with, internal surface 320 and a second open end 334, 344 within the interior of container 200. In this embodiment, second ends 334, 344 overlap with each other such that one of the second ends extends inside of the other second end (i.e., closer to internal surface 320). Tabs 330, 340 may be substantially straight with parallel sides or it may taper from first ends 332, 342 to second ends 334, 344. Alternatively, they may taper in the opposite direction.

Container 300 may be manufactured in any suitable manner known by those of skill in the art. In one embodiment, for example, the entire container 300 and tabs 330, 340 are molded in a single piece. In another embodiment, container 300 may contain first and second portions, such as the first and second portions 100a, 100b shown in FIG. 4.

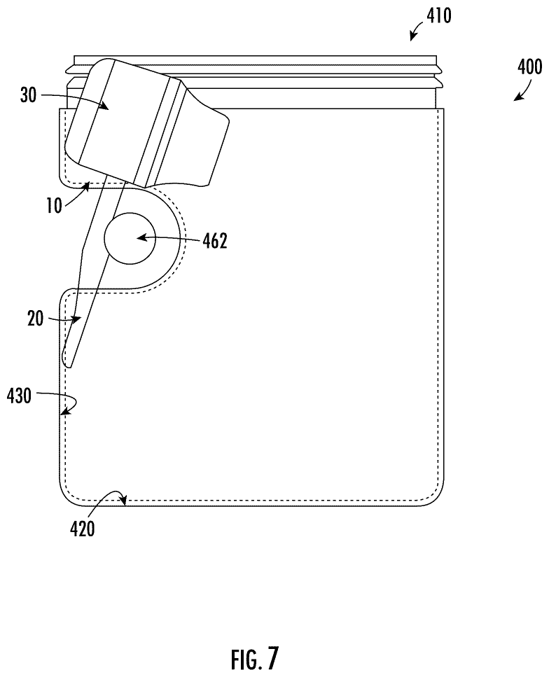

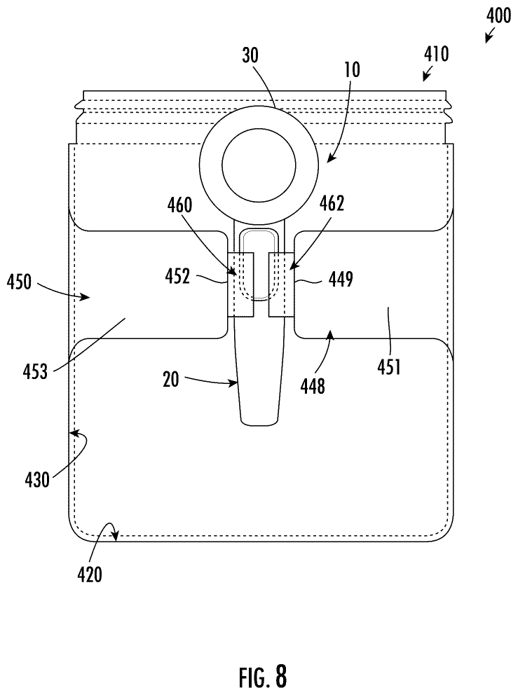

Referring now to FIGS. 7-9, another embodiment of a container 400 comprises a closed distal end 420, an open upper end 410 and an internal surface 430 therebetween. In this embodiment, the external walls of container are pinched towards each other to form a scoop holder. In particular, the external walls are pinched inward to form first surfaces 449, 452 facing each other and second surfaces 451, 453 transverse to, or substantially perpendicular with, first surfaces 449, 452. Thus, the walls form open spaces 448, 450 on the outside of the container 400 that could be gripped by the user.

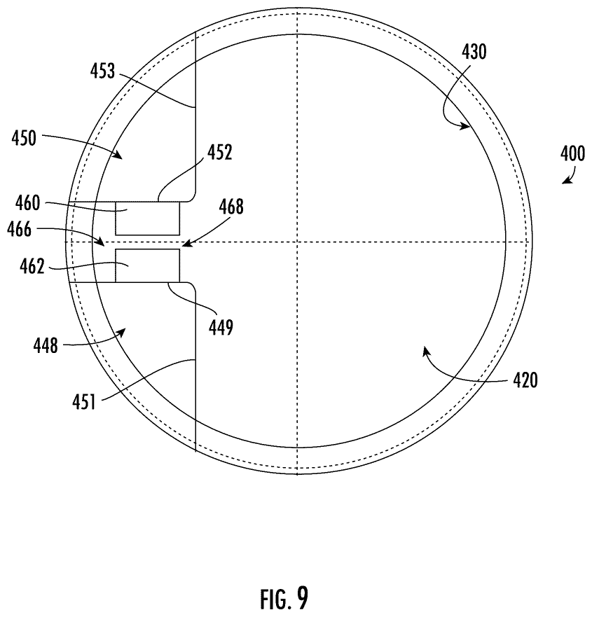

The first portions 449, 452 of each wall face each other to form a scoop holding space 466 therebetween in the interior of container 400 (see FIG. 9). This space 466 provides room for handle 20 of a measuring and dispensing device, such as scoop 10. Thus, instead of separately manufacturing tabs that extend into the interior of the device, the walls of the container 400 are pinched inwardly to form the scoop holder.

The container 400 may further include an elongate member 462, such as a rod, dowel, insert or the like, extending through a portion of space. Elongate member provides additional support to secure handle 20 of scoop 10 within space (see FIG. 7). In certain embodiments, container 400 may comprise a single elongate member 462 that passes entirely through space. In other embodiments (as shown in FIG. 9), container 400 comprises first and second rods, inserts or dowels 460, 462 each extending at least partially into space 466 to create a scoop holder within space 466. In certain embodiments, rods 460, 462 contact each other. In other embodiments, as shown in FIG. 9, the ends of rods 460, 462 form a gap 468 therebetween. In this latter embodiment, the container may be molded from first and second portions (as discussed above), with each portion comprising one of the first and second rods.

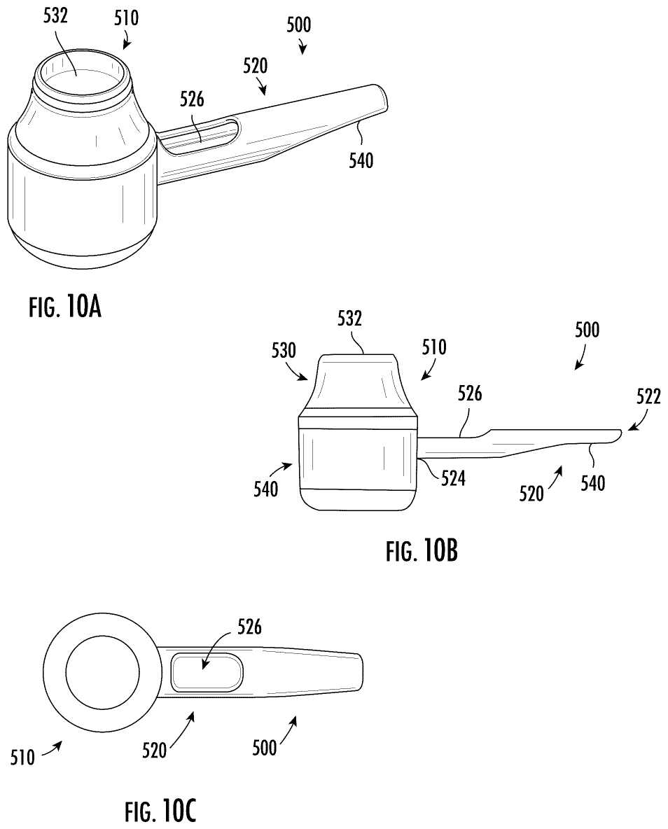

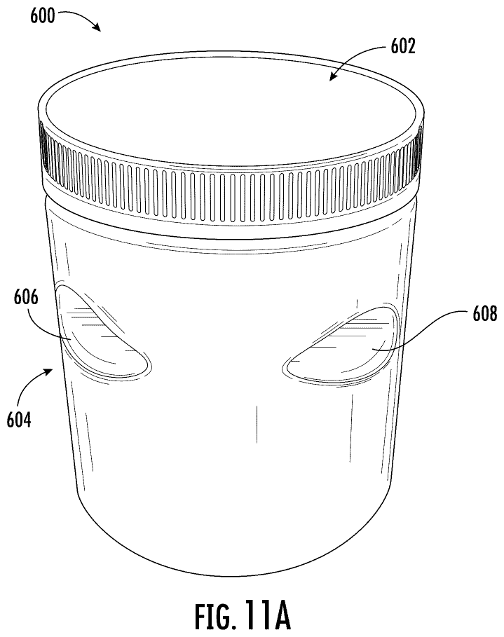

Referring now to FIGS. 10A-10C, an alternative version of a measuring and dispensing device 500 generally comprises an elongated handle 520 formed on, or coupled to, a bowl 510. Bowl 510 comprises a substantially cylindrical container 540 and a substantially conical dispensing element 530 with an opening 532 for receiving and dispensing particles, such as or powder or other granulated or ground particles. Handle 520 comprises a first end 524 coupled to, or integral with, bowl 510 and a second end 522 that may be grasped by a user. Handle 520 may have an angled portion 540 that tapers towards second end 522. Handle 520 further includes a recessed portion 526 that may extend partially through handle 520, or it may extend completely through handle to form a window or passage therethrough. Handle 520 may be curved or contoured to prevent accumulation of unwanted media on any surface of handle 520. In certain embodiments, the handle may be straight and/or it may contain strengthening structures. In certain embodiments, handle 520 may not include windows 526. In other embodiments, other commercially available scoops or delivery devices may be used with any of the containers described herein such that the handle of the delivery devices fits within the space between the protrusions and the inner surface of the peripheral wall of the container.

In certain embodiments, handle 520 and bowl 510 may be formed from a single piece molded construction. The scoop 500 may be molded from a suitable plastic material, which may be molded by blow molding, extrusion, injection, or other manufacturing disciplines. Suitable plastics for forming the scoop include, may include but are not limited to, various polymers, such as nylon (polyamide), acrylic, polyoxymethylene (POM), polystyrene (PS), acrylonitrile butadiene styrene (ABS), polypropylene (PP), polyethylene, thermoplastic polyurethane (TPU), thermoplastic rubber (TPR), high density polyethylene (HDPE), low density polyethylene (LDPE), polyvinyl chloride (PVC), polyethylene terephthalate (PET), and thermoplastic elastomers (TPE) and combinations thereof.

Referring now to FIGS. 11A-11F, another embodiment of a container assembly 600 and a container 604 will now be described. The container assembly 600 generally comprises container 604 and a utensil, such as a scoop, ladle, cup, dipper, tweezer, spoon, fork, pincer or the like, designed to retrieve product from the container 604.

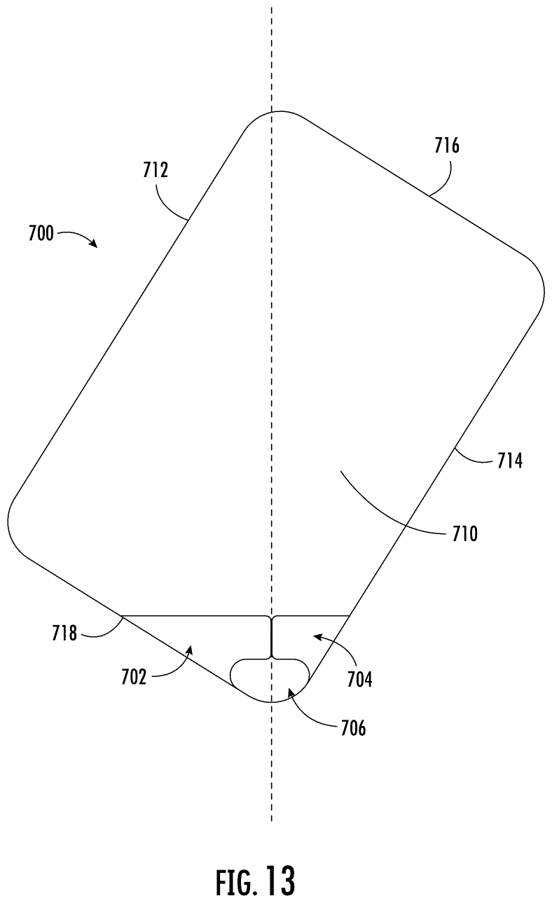

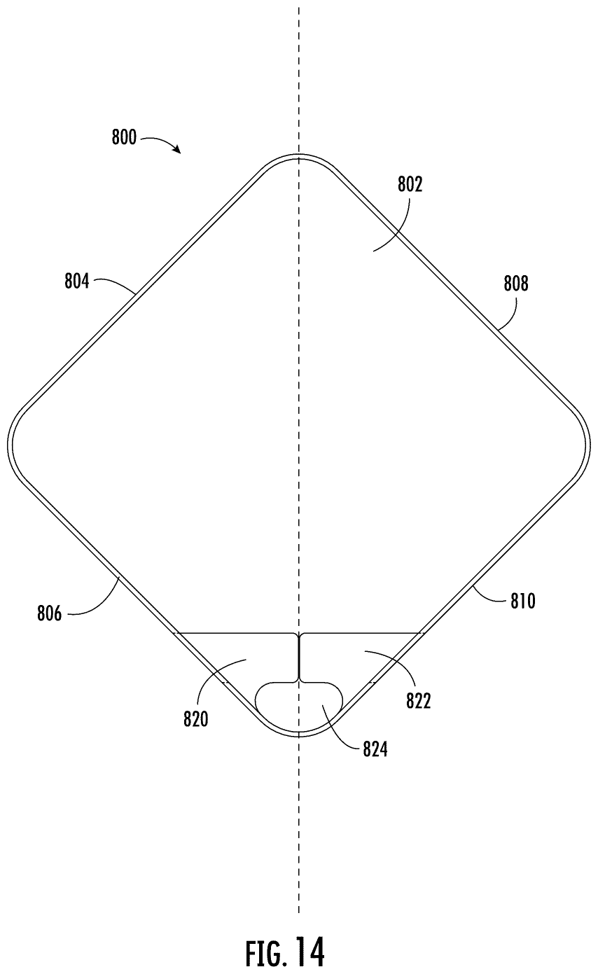

As shown in FIG. 11B, container 600 comprises an open upper end 605, a bottom wall 654 and a peripheral wall 609 extending between opening 605 and bottom wall 654 that generally defines an interior 630 of container 604. Although peripheral wall 609 is shown to be generally cylindrical in FIGS. 11A-11F, it will be understood that it may encompass any suitable shape, such as rectangular, square, spherical, conical, elliptical or the like (see for example FIGS. 13 and 14 discussed in more detail below). As with previous embodiments, container 604 may be composed of various materials suitable to hold a product therein. Various examples include, but are not limited to, being constructed of a metal material, tin, metal plated tin, aluminum or other metal or alloy. Alternatively, the container 604 may be constructed of a suitable plastic material that is recyclable or non-recyclable, such as for example, but not limited to, polystyrene, polystyrene-acrylonitile, acrylonitile-butadiene-styrene, styrene-maleic anhydride, polycarbonate, high density polyethylene, polyethylene copolymers, polypropylene, polypropylene copolymers, polyethylene terephthalate, polyvinylcyclohexane, and the like

In certain embodiments, container 604 may include a mating feature 634 (see FIG. 11B) for cooperating with a sealable lid 602 (see FIG. 11A) that seals open upper end 605 to preserve the product housed within container 604. In certain embodiments, the lid 602 may comprise a threaded connection 634 with container 604 to seal container. In other embodiments, various types of tight interference type sealing connections may be provided between the lid and the upper end 605 of container 604. For example, the connection may be a hinged connection, such as a mechanical hinge, a living hinge or the like, that allows the lid to be opened and closed. Alternatively, the lid may comprise one or more mating features that cooperate with mating features on the upper end of container, such as snap-lock, snap fit or the like. The lid may include one or more components, such as a sheet, film or the like, that are formed from a material substantially impervious to oxygen, moisture and/or light, such as aluminum foil, or a metallic, polymeric, or other type of foil.

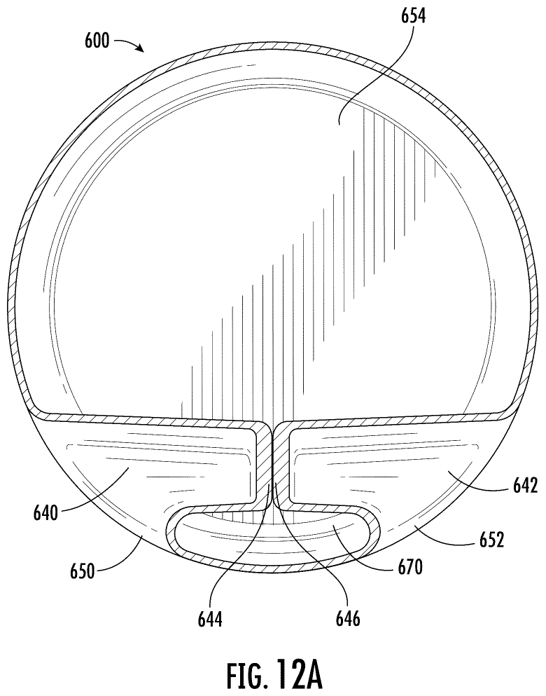

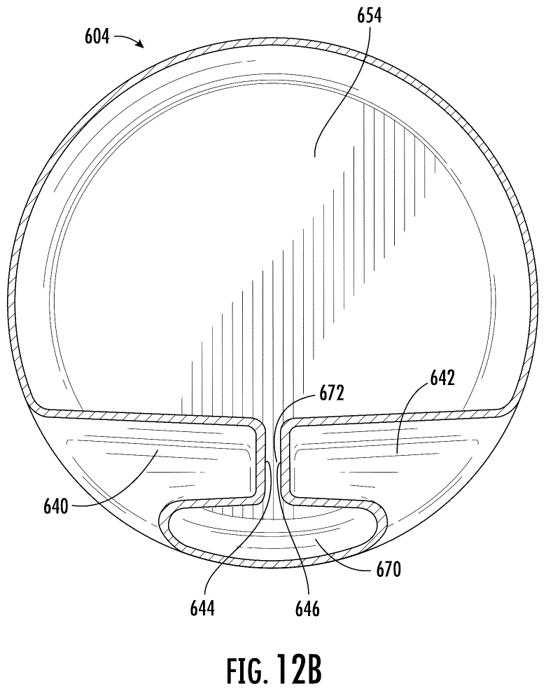

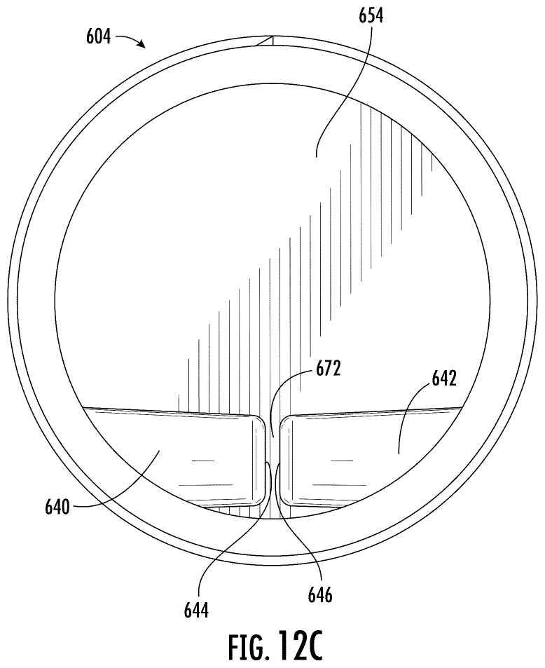

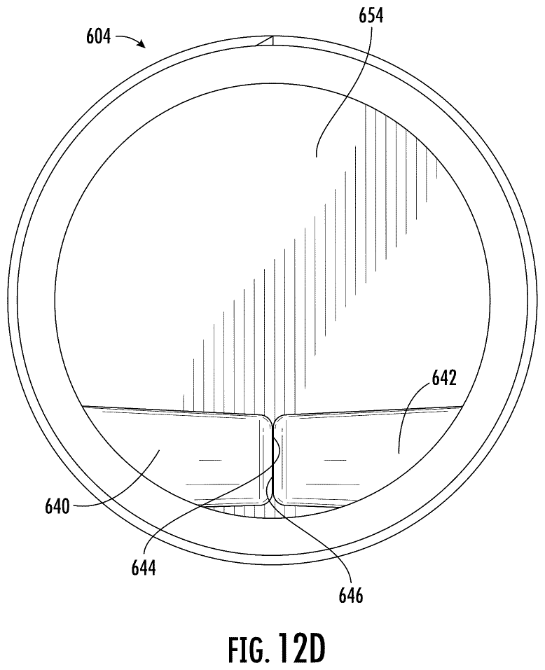

Container 604 further comprises first and second tabs or projections 640, 642 extending from peripheral wall 609 into the interior 630 of container 604. As shown in FIG. 11B, projections 640, 642 each have a first end 648, 652 coupled to, or integral with, peripheral wall 609 and a second end 644, 646 facing each other within the interior of container 604. Projections 640, 642 extend into interior in a direction that creates a space 670 between projections 640, 642 and the inner surface of peripheral wall 609 for receiving a portion of the utensil (see FIGS. 11D and 11E discussed below). Second ends 644, 646 are preferably adjacent to, or near, each other within container 604. In certain embodiments, ends 644, 646 are spaced from each other (see FIGS. 12B and 12C). In other embodiments, ends 644, 646 contact each other (see FIGS. 12A and 12D).

Projections 640, 642 may include an elongate body with any suitable shape. In certain embodiments, projections 640, 642 may taper from first ends 648, 652 to second ends 644, 646. Alternatively, they may taper in the opposite direction, or they may have parallel sides (i.e., substantially cylindrical in shape as shown in FIG. 11D). Projections 640, 642 may be substantially straight, or they may have an arcuate shape bending inwards or outwards relative to peripheral wall 609 within container 604.

Projections 640, 642 form a utensil holder within container 604. Thus, projections 640, 642 are preferably spaced away from the interior surface of peripheral wall 609 by a distance suitable to allow a portion of the utensil to pass through space 670 between projections 640, 642 and the interior surface of peripheral wall 609. Projections 640, 642 are close enough to the interior surface of peripheral wall 609 to prevent the entire utensil from passing downward through this space 670.

In some embodiments, projections 640, 642 extend from an outer surface of peripheral wall 609. In these embodiments, projections 640, 642 may be formed via molding techniques by pressing, deforming or pushing material from peripheral wall 609 inwardly towards the interior of container 604. This allows the projections 640, 642 to be easily molded with the peripheral wall 609 of container in a single molding step from a single mold. Most commercial containers, by contrast, include protrusions for use on the outside of the container for different purposes, such as a handle, threads and the like.

In these embodiments, projections 640, 642 may form openings or channels 606, 608 (see FIG. 11A) that extend through at least a portion of projections 640, 642. These channels 606, 608 are formed as the material of projections 640, 642 is moved or deformed inwardly from the outer surface of the container 604 to its interior 630. In an exemplary embodiment, these channels 606, 608 extend from the outer surface of container 604 to the second ends 644, 646 of projections 640, 642.

In certain embodiments, the ends 644, 646 are thermally bonded or fused together. Thermally bonding projections 640, 642 to each other prevents media from becoming trapped between the projections.

In one embodiment, the utensil comprises a measuring and dispensing device 610, such as a scoop, cup, dipper, ladle, spoon or the like, for use in scooping media from a container 604 (see FIG. 11B) and transferring that substance to another receptacle, such as a water bottle, baby bottle, coffee pot or the like. The media is, for example, any powdered, granulated, ground or other formed substance such as a powder milk product used to feed an infant, or a nutritional substance used by an athlete, coffee, tea, or any other media that may be easily scooped by the presently described dispensing device. The substance need not be a fine powder, but may be, for example, a granular or ground particulate or liquid.

As in previous embodiments, scoop 610 generally comprises an elongated handle 614 formed on, or coupled to, a bowl 612. Bowl 612 comprises a substantially cylindrical container and a substantially conical dispensing element with an opening for receiving and dispensing particles, such as powder or other granulated or ground particles. Handle 614 comprises a first end coupled to, or integral with, bowl 612 and a second end that may be grasped by a user. Handle may include one or more window(s) 616 for allowing excess unwanted media to pass through during scooping. Handle 614 may be curved or contoured to prevent accumulation of unwanted media on any surface of handle 614. In certain embodiments, the handle may be straight and/or it may contain strengthening structures. In certain embodiments, handle 614 may not include windows 616.

In certain embodiments, handle 614 and bowl 612 may be formed from a single piece molded construction. The scoop 610 may be molded from a suitable plastic material, which may be molded by blow molding, extrusion, injection, or other manufacturing disciplines. Suitable plastics for forming the scoop include, may include but are not limited to, various polymers, such as nylon (polyamide), acrylic, polyoxymethylene (POM), polystyrene (PS), acrylonitrile butadiene styrene (ABS), polypropylene (PP), polyethylene, thermoplastic polyurethane (TPU), thermoplastic rubber (TPR), high density polyethylene (HDPE), low density polyethylene (LDPE), polyvinyl chloride (PVC), polyethylene terephthalate (PET), and thermoplastic elastomers (TPE) and combinations thereof.

Of course, other configurations for scoop 610 are contemplated. For example, scoop 610 may have a substantially cylindrical bowl (i.e., without the conical dispensing element). Scoop 610 may have any of the configurations described herein. Alternatively, scoop 610 may have a substantially conical shape (i.e., without the cylindrical component). In other embodiments, scoop 610 may comprise any suitable shape, such as rectangular, square, triangular, cuboid, obloid, pentagonal, hexagonal, or the like. In certain embodiments, scoop 610 may include deformable or pinchable surfaces or handle members designed to flex inwardly to form a spout. Such a configuration is described in commonly assigned co-pending U.S. application Ser. No. 17/900,816, filed Aug. 31, 2022, the complete disclosure of which is incorporated herein by reference for all purposes.

In use, bowl 612 rests upon projections 640, 642 within the interior of container 604 and does not get buried within the granulated media or other product housed in container 604. In addition, projections 640, 642 are preferably positioned such that the entire bowl 612 is disposed below the upper surface of upper end 605 of container 604 (and below mating feature 634) to allow the lid 602 to close container 604 with scoop 610 inside. In some embodiments, projections 640, 642 may include additional shelves 650, 652 extending from peripheral wall 609 to the elongate main body of projections 640, 642 (see FIG. 11D). These shelves 650, 652 provide additional support for bowl 612 to prevent bowl 612 from falling down below projections 640, 642 into the product within container 604.

As shown in FIGS. 11C, 11E and 11F, projections 640, 642 are positioned such that, when scoop 610 is disposed within container 604 such that bowl 612 rests on projections 640, 642, the scoop generally extends in a substantially vertical direction, or a direction that is substantially perpendicular to the plane formed by bottom end of container 604. In certain embodiments, scoop 610 will extend at an angle relative to the bottom end of container of about 45 degrees to about 90 degrees, or about 60 degrees to about 90 degrees, or about 75 degrees to about 90 degrees. This ensures that bowl 612 remains above handle 614 within container 604 and is easily grasped by the user when lid 602 is opened and the user desires to use scoop 610 to retrieve product from container 604. In addition, this ensures that product generally does not fill up within bowl 612 as it rests upon projections 640, 642.

Container 604 may be sized such that the space created between the bottom of lid 602 and the distal end of the bowl 612 is small enough such that scoop 610 does not become loose and fall into the media within container 604. In some embodiments, scoop 610 may rest within container 604 without contacting projections 640, 642.

FIGS. 13 and 14 illustrate alternative embodiments of the container. As shown in FIG. 13, a container 700 comprises a substantially rectangular configuration with two opposing longer walls 712, 714 and two opposing shorter walls 716, 718. Container 700 further comprises first and second projections 702, 704 extending from one of the longer walls 714 and one of the shorter walls 718. As in the previous embodiments, projections 702, 704 extend towards each other and have inner ends that face each other (i.e., in contact with each other, or forming a space therebetween). Projections 702, 704 are configured to form a space or gap 706 with the inner surface of walls 714, 718 for retaining a utensil to the interior of container 700.

Referring now to FIG. 14, a container 800 comprises a substantially square configuration with four congruent lines 804, 806, 808, 810 forming an interior 802 therebetween. Container 800 further comprises first and second projections 820, 822 extending from an inner surface of two of the walls 806, 810 to form a space or gap 824 for retaining a utensil to the interior of container 800.

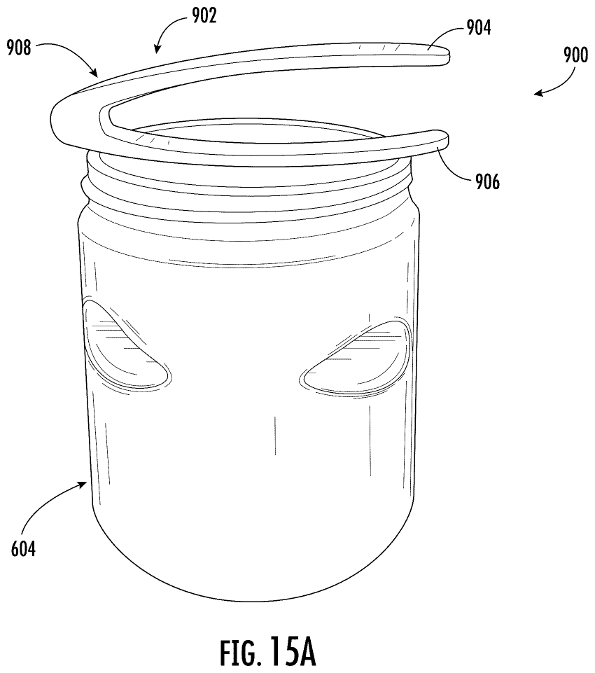

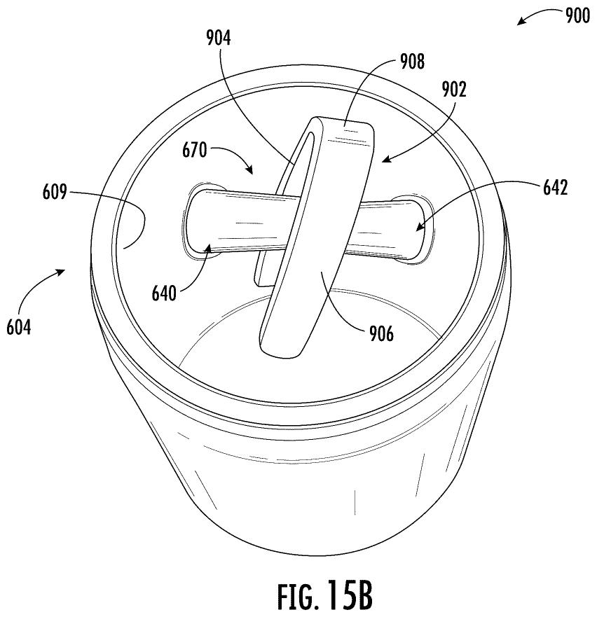

In another embodiment, the utensil comprises a tweezer or pincer designed to retrieve a product that is generally in particle form, such as edible cannabis, gummies, flowers, buds, candy, chocolates, baked goods and the like. As shown in FIGS. 15A and 15B, a container assembly 900 comprises a tweezer 902 and container 604 (described above). Tweezer 902 generally comprises first and second arms 904, 906 pivotally coupled to each other at a hinge 908 that allows the user to grasp tweezer 902 and open and close arms 904, 906 to retrieve product within container 604.

As shown in FIG. 15B, projections 640, 642 are designed to allow tweezer 902 to be placed into container 902 such that one of the arms 904 passes through space 670 between projections 640, 642 and the inner surface of peripheral wall 609 of container 604. The other arm 906 may extend downwardly on the other side of projections 604, 606 and the hinge 908 may be positioned above, or on, the upper surface of projections 640, 642. This allows tweezer 902 to be retained within container 604 without dropping down and becoming buried within the product.

Other embodiments will be apparent to those skilled in the art from consideration of the specification and practice of the embodiment disclosed herein. It is intended that the specification and examples be considered as exemplary only, with a true scope and spirit of the embodiment being indicated by the following claims.

For example, in a first aspect, a first embodiment is a container for use with a utensil. The container comprises a closed lower end, an upper end with an opening and a peripheral wall between the upper and lower ends defining an interior of the container and a projection extending from the peripheral wall into an interior of the container. The projection is configured to removably retain the utensil within the interior of the container

A second embodiment is the first embodiment, further comprising a mating feature for cooperating with a lid, wherein the projection is disposed between the mating feature and the closed lower end. This creates a space between the bottom of the lid and an end of the utensil that is small enough to inhibit or prevent the utensil from becoming loose and fall into the media.

A third embodiment is any combination of the above embodiments, wherein the projection comprises an elongate body that forms a space between the elongate body and an inner surface of the peripheral wall, wherein the space is sized to receive a portion of the dispensing device.

A 4^{th} embodiment is any combination of the above embodiments, wherein the at least a portion of the utensil extends through the space between the elongate body of the projection and the inner surface of the peripheral wall such that the utensil is retained below the upper end of the container.

A 5^{th} embodiment is any combination of the above embodiments, wherein the projection is configured such that the utensil extends through the space in a direction having an angle of about 45 degrees to about 90 degrees relative to the closed lower end.

A 6^{th} embodiment is any combination of the above embodiments, wherein the direction is substantially perpendicular to the closed lower end.

A 7^{th} embodiment is any combination of the above embodiments, wherein the projection is a first projection, the container further comprising a second projection extending from the peripheral wall to the interior of the container, wherein the first and second projections each comprise an elongate body that together form a space between the projections and an inner surface of the peripheral wall, wherein the space is sized to receive a portion of the utensil.

An 8^{th} embodiment is any combination of the above embodiments, wherein the first and second projections each have a first end adjacent an inner surface of the peripheral wall and a second end within the interior of the container, wherein the second ends are adjacent to each other.

A 9^{th} embodiment is any combination of the above embodiments, wherein the first and second ends overlap with each other.

A 10^{th} embodiment is any combination of the above embodiments, wherein the first and second ends contact each other.

An 11^{th} embodiment is any combination of the above embodiments, wherein the first and second projections are non-congruent.

A 12^{th} embodiment is any combination of the above embodiments, wherein the first and second projections are substantially aligned with each other.

A 13^{th} embodiment is any combination of the above embodiments, wherein the peripheral wall has an outer surface and the first and second projections each comprise an internal channel, wherein the internal channel of each of the first and second projections extends from the outer surface of the peripheral wall to the second end of the projections.

A 14^{th} embodiment is any combination of the above embodiments, wherein the internal channel of the first projection communicates with the internal channel of the second projection forming a passage from the outer surface of a first side of the peripheral wall to the outer surface of a second side of the peripheral wall.

A 15^{th} embodiment is any combination of the above embodiments, wherein the projection and the container are molded together in a single mold.

A 16^{th} embodiment is any combination of the above embodiments, wherein the container comprises a first portion and a second portion, wherein the first projection is molded with the first portion and the second projection is molded with the second portion and come together to become a single integral component.

A 17^{th} embodiment is any combination of the above embodiments, further comprising a sealable lid coupled to the container. The lid and the projections are sized to create a space between the bottom of the lid and an end of the utensil that is small enough to inhibit or prevent the utensil from becoming loose and fall into the media.

An 18^{th} embodiment is any combination of the above embodiments, wherein the utensil is disposed below the sealable lid within the interior of the container when the utensil is retained by the projection. The lid and the projections are sized to create a space between the bottom of the lid and an end of the utensil that is small enough to inhibit or prevent the utensil from becoming loose and fall into the media.

A 19^{th} embodiment is any combination of the above embodiments, wherein the utensil comprises a scoop having a handle and a bowl.

A 20^{th} embodiment is any combination of the above embodiments, wherein the handle extends through the space between the peripheral wall of the container and the projection and the bowl of the dispensing device rests on the projection below the upper end of the container.

A 21^{st} embodiment is any combination of the above embodiments, wherein the utensil comprises tweezers.

In another aspect, a first embodiment is a container assembly comprising a container having a closed lower end, an upper end with an opening and a peripheral wall between the upper and lower ends defining an interior of the container; a utensil; and a projection extending from the peripheral wall into an interior of the container, the projection being configured to removably retain the dispensing device within the interior of the container.

A second embodiment is the first embodiment, further comprising a mating feature for cooperating with a lid, wherein the projection is disposed between the mating feature and the closed lower end such that the utensil is retained below the upper end of the container. The lid and the projections are sized to create a space between the bottom of the lid and an end of the utensil that is small enough to inhibit or prevent the utensil from becoming loose and fall into the media.

A third embodiment is any combination of the above embodiments, wherein the projection forms a space between the projection and an inner surface of the peripheral wall, wherein the space is sized to receive a portion of the dispensing device.

A 4^{th} embodiment is any combination of the above embodiments, wherein the utensil is disposed within the space such that the utensil extends in a direction having an angle of about 45 degrees to about 90 degrees relative to the closed lower end.

A 5^{th} embodiment is any combination of the above embodiments, wherein the direction is substantially perpendicular to the closed lower end.

A 6^{th} embodiment is any combination of the above embodiments, wherein the projection is a first projection, the container further comprising a second projection extending from the peripheral wall to the interior of the container, wherein the first and second projections form a space between the projections and an inner surface of the peripheral wall, wherein the space is sized to receive a portion of the dispensing device.

A 7^{th} embodiment is any combination of the above embodiments, wherein the first and second projections each have a first end in contact with an inner surface of the peripheral wall and a second end within the interior of the container, wherein the second ends are adjacent to each other.

An 8^{th} embodiment is any combination of the above embodiments, wherein the first and second ends overlap with each other.

A 9^{th} embodiment is any combination of the above embodiments, wherein the first and second ends contact each other.

A 10^{th} embodiment is any combination of the above embodiments, wherein the first and second projections are non-congruent.

An 11^{th} embodiment is any combination of the above embodiments, wherein the first and second projections are substantially aligned with each other.

A 12^{th} embodiment is any combination of the above embodiments, wherein the peripheral wall has an outer surface and the first and second projections each comprise an internal channel, wherein the internal channel of each of the first and second projections extends from the outer surface to the second end.

A 13^{th} embodiment is any combination of the above embodiments, wherein the internal channel of the first projection communicates with the internal channel of the second projection forming a passage from the outer surface of a first side of the peripheral wall to the outer surface of a second side of the peripheral wall.

A 14^{th} embodiment is any combination of the above embodiments, wherein the projection and the container are molded together in a single mold.

A 15^{th} embodiment is any combination of the above embodiments, wherein the container comprises a first portion and a second portion, wherein the first projection is molded with the first portion and the second projection is molded with the second portion.

A 16^{th} embodiment is any combination of the above embodiments, further comprising a sealable lid coupled to the container. The lid and the projections are sized to create a space between the bottom of the lid and an end of the utensil that is small enough to inhibit or prevent the utensil from becoming loose and fall into the media.

A 17^{th} embodiment is any combination of the above embodiments, wherein the utensil is disposed below the sealable lid within the interior of the container when the utensil is retained by the projection. The lid and the projections are sized to create a space between the bottom of the lid and an end of the utensil that is small enough to inhibit or prevent the utensil from becoming loose and fall into the media.

An 18^{th} embodiment is any combination of the above embodiments, wherein the utensil comprises a scoop having a handle and a bowl.

A 19^{th} embodiment is any combination of the above embodiments, wherein the handle extends through the space between the peripheral wall of the container and the projection and the bowl of the dispensing device rests on the projection below the upper end of the container.

A 20^{th} embodiment is any combination of the above embodiments, wherein the utensil comprises tweezers.

In another aspect, an infant formula product is provided comprising the container of any of the above embodiments, and further comprising a powdered infant formula.

In another aspect, a coffee product is provided comprising the container of any of the above embodiments, and further comprising coffee.

In another aspect, a powdered or granulated hydration product is provided comprising the container of any of the above embodiments, and further comprising a powdered or granulated hydration media.

In another aspect, a nutritional supplement product is provided comprising the container of any of the above embodiments, and further comprising a nutritional supplement composition.

In another aspect, a product is provided comprising the container of any of the above embodiments, and further comprising cannabis.

In another aspect, a first embodiment is a method of manufacturing a container comprising: molding a first portion of the container, the first portion comprising a lower end with a bottom wall, an open upper end, and a peripheral wall between the upper and lower ends; molding a second portion of the container, the second portion comprising a lower end with a bottom wall, an open upper end, and a peripheral wall between the upper and lower ends; wherein at least one of the first and second portions comprises a projection extending from an inner surface of the peripheral wall; and joining the first portion with the second portion.

A second embodiment is the first embodiment, wherein the first and second portions are congruent.

A third embodiment is any combination of the first two embodiments, wherein the first portion comprises a first projection extending from the inner surface of the peripheral wall of the first portion and the second portion comprises a second projection extending from an inner surface of the peripheral wall of the second portion.

A 4^{th} embodiment is any combination of the above embodiments, wherein the first and second projections each have a first end in contact with the peripheral wall of the first and second portions, respectively, and a second end extending into the interior of the container, wherein the second ends are adjacent to each other.

A 5^{th} embodiment is any combination of the above embodiments, wherein the peripheral wall has an outer surface and the first and second projections each comprise an internal channel, wherein the internal channel of each of the first and second projections extends from the outer surface to the second end.

A 6^{th} embodiment is any combination of the above embodiments, further comprising pressing first and second portions of the peripheral wall inwardly towards the interior of the container to form the first and second projections.

A 7^{th} embodiment is any combination of the above embodiments, wherein the internal channel of the first projection communicates with the internal channel of the second projection forming a passage from the outer surface of a first side of the peripheral wall to the outer surface of a second side of the peripheral wall.

An 8^{th} embodiment is any combination of the above embodiments, further comprising forming a sealable lid and attaching the sealable lid to the upper ends of the first and second portions of the container. The lid and the projections are sized to create a space between the bottom of the lid and an end of the utensil that is small enough to inhibit or prevent the utensil from becoming loose and fall into the media.

1. A container for use with a utensil, the container comprising:
a closed lower end, an upper end with an opening and a peripheral wall between the upper and lower ends defining an interior of the container; and
a first projection extending from the peripheral wall into an interior of the container,
a second projection extending from the peripheral wall into the interior of the container, wherein the first and second projections each have a first end adjacent an inner surface of the peripheral wall and a second end within the interior of the container and wherein the second end of the first projection is in contact with the second end of the second projection, the first and second projections being configured to removably retain the utensil within the interior of the container.

2. The container of claim 1, further comprising a mating feature for cooperating with a lid, wherein the first and second projections are disposed between the mating feature and the closed lower end.

3. The container of claim 1, wherein the first and second projections each comprise an elongate body that forms a space between the elongate body and an inner surface of the peripheral wall, wherein the space is sized to receive a portion of the utensil.

4. The container of claim 3, wherein the at least a portion of the utensil extends through the space between the elongate body of the first and second projections and the inner surface of the peripheral wall such that the utensil is retained below the upper end of the container.

5. The container of claim 4, wherein the first and second projections are configured such that the utensil extends through the space in a direction having an angle of about 45 degrees to about 90 degrees relative to the closed lower end.

6. (canceled)

7. (canceled)

8. (canceled)

9. The container of claim 1, wherein the peripheral wall has an outer surface and the first and second projections each comprise an internal channel, wherein the internal channel of each of the first and second projections extends from the outer surface of the peripheral wall to the second end of the projections.

10. (canceled)

11. The container of claim 1, further comprising a sealable lid coupled to the container.

12. The container of claim 11, wherein the utensil is disposed below the sealable lid within the interior of the container when the utensil is retained by the projection and wherein the lid and the projections are sized to create a space between a bottom of the lid and an end of the utensil small enough to inhibit or prevent the utensil from becoming loose.

13. A container assembly comprising:
a container having a closed lower end, an upper end with an opening and a peripheral wall between the upper and lower ends defining an interior of the container;
a utensil; and
wherein a portion of the peripheral wall extends inwardly toward the interior of the container to form a projection,
the projection being configured to removably retain the utensil within the interior of the container.

14. The container assembly of claim 13, further comprising a mating feature for cooperating with a lid, wherein the projection is disposed between the mating feature and the closed lower end such that the utensil is retained below the upper end of the container.

15. The container assembly of claim 13, wherein the projection forms a space between the projection and an inner surface of the peripheral wall, wherein the space is sized to receive a portion of the utensil.

16. The container assembly of claim 15, wherein the utensil is disposed within the space such that the utensil extends in a direction having an angle of about 45 degrees to about 90 degrees relative to the closed lower end.

17. The container assembly of claim 13, wherein the projection is a first projection, the container further comprising a second projection extending from the peripheral wall to the interior of the container, wherein the first and second projections form a space between the projections and an inner surface of the peripheral wall, wherein the space is sized to receive a portion of the utensil.

18. The container assembly of claim 17, wherein the first and second projections each have a first end in contact with an inner surface of the peripheral wall and a second end within the interior of the container, wherein the second ends are adjacent to each other.

19. The container assembly of claim 18, wherein the first and second ends contact each other.

20. The container of claim 18, wherein the first and second projections are substantially aligned with each other.

21. The container assembly of claim 17, wherein the peripheral wall has an outer surface and the first and second projections each comprise an internal channel, wherein the internal channel of each of the first and second projections extends from the outer surface to the second end.

22. (canceled)

23. The container assembly of claim 13, wherein the container comprises a first portion and a second portion, wherein the first projection is molded with the first portion and the second projection is molded with the second portion.

24. The container assembly of claim 13, further comprising a sealable lid coupled to the container.

25. The container assembly of claim 24, wherein the utensil is disposed below the sealable lid within the interior of the container when the utensil is retained by the projection.

26. The container assembly of claim 13, wherein the utensil comprises a scoop having a handle and a bowl.

27. The container assembly of claim 26, wherein the handle extends through the space between the peripheral wall of the container and the projection and the bowl of the utensil rests on the projection below the upper end of the container.

28. The container assembly of claim 13, wherein the utensil comprises tweezers.

29. An infant formula product comprising the container of claim 13 and further comprising a powdered infant formula.

30. A product comprising the container of claim 13 and further comprising cannabis.
